(19) United States
(12) Patent Application Publication
(10) Pub. No.: US 2012/0316979 A1
(43) Pub. Date: Dec. 13, 2012

(54) Method of Developing Flight Infrastructure in Conjunction with a Sale of an Aircraft

(76) Inventors: William W. Fulton, Haslet, TX (US); Nicholas D. Lappos, Southlake, TX (US)

(21) Appl. No.: 13/580,341

(22) PCT Filed: May 12, 2010
(86) PCT No.: PCT/US10/34566

§ 371 Date: Aug. 21, 2012

(51) Int. Cl. G06Q 30/06; G06Q 30/00

(52) U.S. Cl. 705/26.1; 705/1.1

(57) ABSTRACT

A method for providing WAAS infrastructure in conjunction with the sale of a WAAS enabled aircraft includes developing a sales package for a customer. The price of the sales package preferably includes a WAAS enabled aircraft and a WAAS infrastructure. The method further includes assembling a WAAS enabled aircraft and developing the WAAS infrastructure using a computer. The method also includes providing the customer with the WAAS enabled aircraft and the WAAS infrastructure.

### TECHNICAL FIELD

The present application relates in general to the field of aircraft flight infrastructure.

### DESCRIPTION OF THE PRIOR ART

Aircraft customers are able to buy rotorcraft having a wide range of avionics platforms. Typically, customers buy rotorcraft having avionics systems which correspond with conventional Federal Aviation Administration (FAA) radar based flight procedures. Currently, the FAA is implementing a Wide Area Augmentation System (WAAS) which provides for air navigation using a Global Positioning Systems (GPS). WAAS is able to account for variations in GPS satellite signals, thereby creating a highly accurate air navigation system. In order to fly an aircraft using WAAS, the customer needs a WAAS enabled aircraft, as well as a WAAS infrastructure.

WAAS avionic utility is currently limited by a lack of satellite based infrastructure proliferation, and, as result, the full safety benefits of obstacle clearance and weather risk mitigation have not been completely realized by end users, operators, and regulatory authority.

Aircraft customers desire to operate aircraft in a WAAS environment; however, many aircraft customers are unable to justify the cost, resources, and time that it takes to develop the WAAS infrastructure required to operate a WAAS enabled aircraft in their specific and unique operating environment.

### BRIEF DESCRIPTION OF THE DRAWINGS

The novel features believed characteristic of the method of the present application are set forth in the appended claims. However, the method itself, as well as a preferred mode of use, and further objectives and advantages thereof, will best be understood by reference to the following detailed description when read in conjunction with the accompanying drawings, in which the leftmost significant digit(s) in the reference numerals denote(s) the first figure in which the respective reference numerals appear, wherein:

FIG. 1 is a side view of an exemplary WAAS enabled aircraft;

FIG. 2 is a perspective cross-sectional view of the WAAS enable aircraft of FIG. 1, taken at section arrows 2-2;

FIG. 3 is a schematic view of a WAAS flight procedure;

FIG. 4 is a schematic flow diagram of a method for developing WAAS infrastructure in conjunction with a sale of a WAAS enabled aircraft, according to the preferred embodiment; and

FIG. 5 is a schematic block diagram of a computer system used in the method of the present application.

While the method of the present application is susceptible to various modifications and alternative forms, specific embodiments thereof have been shown by way of example in the drawings and are herein described in detail. It should be understood, however, that the description herein of specific embodiments is not intended to limit the method to the particular forms disclosed, but on the contrary, the intention is to cover all modifications, equivalents, and alternatives falling within the spirit and scope of the application as defined by the appended claims.

### DESCRIPTION OF THE PREFERRED EMBODIMENT

Illustrative embodiments of the method of the present application are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

A “Wide Area Augmentation System (WAAS)” is a highly accurate air navigation system developed by the Federal Aviation Administration (FAA) and cooperatively implemented by industry, end-user operators, and regulatory authority. WAAS accounts for variations in Global Positioning System (GPS) technology, thereby providing the accuracy necessary for allowing WAAS enabled aircraft to rely on WAAS for all aspects of precision aircraft navigation. For the purposes of this disclosure, the term “WAAS” should be interpreted to include other navigation systems which are similar, but are known by different names due to being implemented by administrations other than the FAA. For example, the International Civil Aviation Organization (ICAO) refers to a WAAS system as a Satellite Based Augmentation System (SBAS). Other SBAS systems, like the European Geostationary Navigation Overlay Service (EGNOS), serve the function as WAAS, but are regulated by airspace authority other than the FAA.

It should be noted that for purposes of this disclosure, a “customer” is not only a buyer of an aircraft, but the term “customer” should be construed liberally to include persons or entities which operate WAAS enabled aircraft 101. For example, the customer can be a business entity which operates aircraft 101 in conjunction with an Emergency Medical Service (EMS). Another non-exclusive example of a customer is a government entity which operates a fleet of aircraft for law enforcement purposes. Additionally, the customer can also be a pilot of the aircraft.

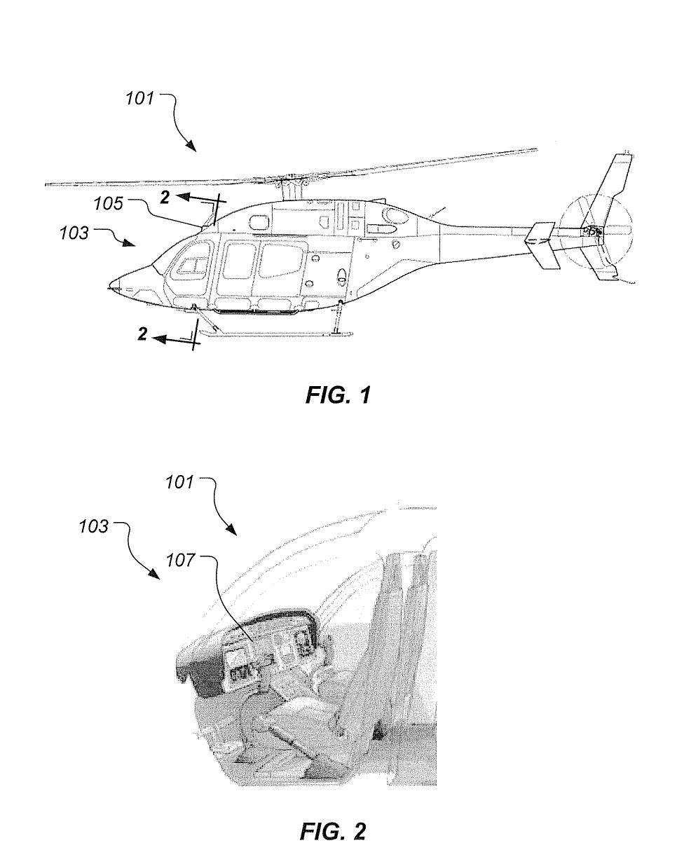

FIG. 1 depicts an exemplary WAAS enabled aircraft 101. WAAS enabled aircraft 101 can include equipment necessary to operate in a WAAS environment, as well as regulatory certifications that may be required. WAAS enabled aircraft 101 is shown to be a helicopter; however, other aircraft, such as an airplane, a tiltrotor, gyrocopter, flying car, and the like, may be WAAS enabled aircraft 101. In the preferred embodiment, WAAS enabled aircraft 101 is custom built to a customer's requirements having a WAAS compatible avionics system 103. System 103 includes at least one GPS antennae 105 for receiving GPS related signals.

Referring now to FIG. 2, the pilot and co-pilot portions of aircraft 101 are shown. System 103 includes a WAAS certified navigation unit 107. Units such as a Garmin GNS 530W are particularly well suited for this application. WAAS flight procedures are loaded into navigation unit 107 allowing a pilot to navigate aircraft 101 according to a specified WAAS flight procedure. Navigation unit 107 receives and interprets both GPS and WAAS geospatial satellite correction data from antennae 105 (shown in FIG. 1), thereby providing the pilot with precision vertical and longitudinal guidance in order to navigate aircraft 101 in a specified WAAS flight pattern for Terminal Instrument Procedures (TERPS).

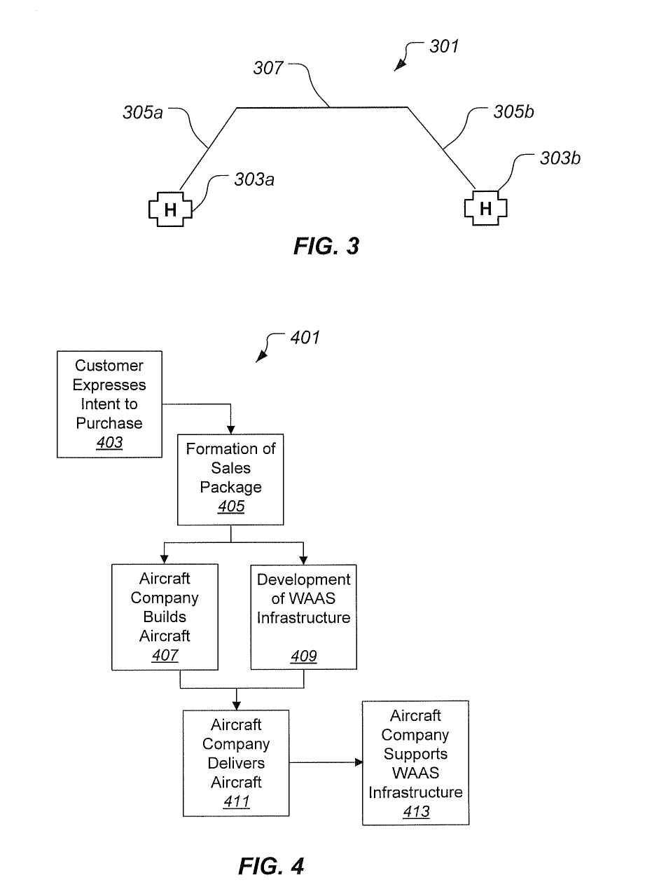

FIG. 3 depicts, for illustrative purposes, an exemplary schematic of a WAAS flight procedure 301. WAAS flight procedure 301 is part of WAAS infrastructure for operation of WAAS aircraft 101 in a WAAS environment. A departure area 303a and an arrival area 303b are shown as helipads as an illustrative example. A primary WAAS route 307 is the primary navigation route between departure area 303a and arrival area 303b. A departure route 305a is illustrated to show the flight path between departure area 303a and primary WAAS route 307, while an arrival approach 305b is illustrated to show the flight path between primary WAAS route 307 and arrival area 303b. It should be appreciated that WAAS flight procedure 301 shown in FIG. 3 is a simplified figure meant to schematically exemplify a basic configuration. It should also be appreciated that development of WAAS flight procedure 301 may be a very time consuming and complex procedure. As such, development WAAS flight procedure 301 is typically a major obstacle for a potential operator.

WAAS flight procedure 301 is configured according to certain desirables of the customer and requirements of the FAA. For example, WAAS flight procedure 301 can be configured to provide the most efficient route between departure area 303a and arrival area 303b, thereby resulting in a decrease in fuel consumption and carbon footprint. WAAS flight procedure 301 can also be configured so as to produce the least possible environmental noise pollution. Also, safety can be improved by configuring WAAS flight procedure 301 so that WAAS enabled aircraft 101 avoids populated areas, avoids major ground transportation intersections, and avoids high aircraft traffic areas. Furthermore, WAAS flight procedure 301 can be private to the customer so that the airspace used in the WAAS flight procedure 301 is exclusive to the customer. Exclusivity in WAAS flight procedure 301 decreases the likelihood of a mid-air collision with another aircraft, especially during times of low visibility or Instrument Meteorological Conditions (IMC). In addition, WAAS flight procedure 301 can permit the operation of aircraft 101 during low visibility environmental conditions, such as IMC, that would otherwise preclude the operation of an aircraft. When the customer is an operator of Emergency Medical Service (EMS) aircraft, then WAAS enabled aircraft 101 and WAAS flight procedure 301 allow the customer to increase revenue by being able to operate in a wider range of flight conditions. WAAS also allows the customer to operate WAAS enabled aircraft 101 according to steeper glide path angles, thereby allowing customers to fly in and out of otherwise inaccessible areas. For example, WAAS flight procedure 301 can include a localizer performance with vertical guidance (LPV) approach procedure to facilitate an approach and landing at the customer desired landing area. As such, significant advantages to operating WAAS enabled aircraft 101 in a WAAS environment include: improving safety, increasing efficiency, reducing environmental impact, and increasing operational capacity, to name a few.

However, in order for a customer to operate WAAS enabled aircraft 101 in a WAAS environment, important WAAS infrastructure should be developed. Development of WAAS infrastructure is expensive and time consuming for the customer. A method of the present application seeks to incorporate development of WAAS infrastructure in conjunction with the sale of aircraft 101, thereby providing the customer with a practical solution for WAAS infrastructure development, so as to allow the customer to purchase and operate WAAS enabled aircraft 101.

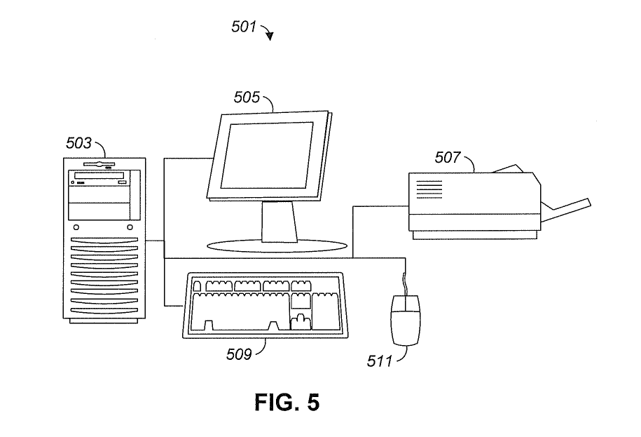

FIG. 4 represents a schematic flow diagram of a method 401, according to the preferred embodiment, for developing WAAS infrastructure in conjunction with a sale of WAAS enabled aircraft 101 to a customer. In step 403, a customer communicates to an aircraft company an intent to purchase a WAAS enabled aircraft 101. Typically, sales personnel represent the aircraft company in regard to the sales transaction. The sales personnel record the financial information of the customer, on a computer system 501 (shown in FIG. 5), in order to qualify the customer for financing.

Step 405 includes the option for the customer to bargain for the purchase of WAAS enabled aircraft 101 and development of WAAS infrastructure. In the preferred embodiment, a sales package includes a bundled price for the WAAS enabled aircraft 101 and development of the WAAS infrastructure. However, the sales package may also segregate the prices of aircraft 101 and the WAAS infrastructure. Furthermore, the sales package may actually be segregated into multiple sales agreements. For example, the sales package may include one WAAS enabled aircraft 101 along with the development of an established WAAS flight procedure 301, the development to include certification of WAAS flight procedure 301 and customer training in operating aircraft 101 in the established WAAS flight procedure 301. It should be appreciated that more than one aircraft 101 and WAAS flight procedure 301 can be bargained for in step 405. It should also be appreciated that the sales personnel are typically different from the personnel involves in developing the WAAS infrastructure. Typically the customer is required to pay a small percentage of the total cost of the sales package after customer and the sales personnel agree to the terms of the sales package. However, the customer can at least partially finance the cost of the WAAS infrastructure along with cost of the WAAS enabled aircraft.

Method 401 continues with steps 407 and 409 occurring at least partially in the same time frame. Step 407 involves the manufacturing of WAAS enabled aircraft 101 according the customer's requirements. Exemplary customer requirements can be: paint color, seating arrangement, and avionics, to name a few. Moreover, a basic aircraft airframe may be transformed into WAAS enabled aircraft 101 during step 407. Step 409 involves the aircraft company developing the WAAS infrastructure bargained for in the sale package of step 405. The aircraft company may perform step 409 with internal personnel, or the aircraft company may hire outside personnel to perform part or all of the development of WAAS infrastructure. WAAS infrastructure may include the development, certification, training of WAAS flight procedure 301, as well as any enhancements or improvements to existing infrastructure, such as pre-existing heliports or helipads, for the safe use of WAAS LPV procedures. The development of WAAS flight procedure 301 may involve inspection of the customer desired departure area 303a and arrival area 303b. Computer system 501 is used to record data pertaining to each departure area 303a, arrival area 303b, as wells as to optimize each procedure within constraints of existing airspace structure. Computer system 501 is also used to develop departure route 305a, primary WAAS route 307, and arrival approach 305b. Flight procedure 301 is preferably certified by the FAA, or other authoritative agency. Flight procedure 301 is preferably recorded onto a memory device, such as a Subscriber Identity Module (SIM) card, which can be conveniently loaded into WAAS compatible avionics system 103 of aircraft 101. The memory device, and any software updates, is tracked for relevant and necessary updates that may affect the flight safety or utility of WAAS LPV procedures. Development of WAAS infrastructure is typically very time consuming and may incorporate the contributions of a variety of personnel.

In step 411 of method 401, aircraft company delivers WAAS enabled aircraft 101 to the customer. At this point in the process, WAAS infrastructure is at least partially developed. In some embodiments, WAAS infrastructure is completed in step 409; however, in the preferred embodiment development of WAAS infrastructure for the customer continues after aircraft 101 is delivered to the customer in step 411. In the preferred embodiment, at least one WAAS flight procedure 301 is fully developed, loaded into WAAS certified navigation unit 107, and delivered with WAAS enabled aircraft 101 in step 411. As such, the customer may operate WAAS enabled aircraft 101 in a WAAS environment after receipt of aircraft 101. As such, the customer is able to operate the aircraft soon after delivery, thereby avoiding the costly delay of having to wait for development of WAAS flight procedure 301, or other WAAS infrastructure.

A step 413 represents continued development, training, maintenance of WAAS infrastructure for the customer. For example, customer may take delivery of aircraft 101 in step 411 and then be provided WAAS training in step 413. In addition, customer may receive additional WAAS flight procedures 301 in step 413. Furthermore, step 413 includes continued development, training, maintenance of flight infrastructure bargained for by the customer.

Referring to FIG. 5 in the drawings, a block diagram is shown of an example of a specific machine that can serve as an embodiment of computer system 501 for performing the method 401 for developing WAAS infrastructure in conjunction with the sale of a WAAS enabled aircraft 101. System 501 includes a computer 503, which serves as a data storage system and a data processing system. Computer 503 includes components commonly associated with personal computers, workstations, and servers, such as a central processing unit (CPU), non-volatile memory, such as a hard drive, volatile memory, such as random access memory (RAM), communication ports and controllers, such as universal serial bus (USB) ports, and can also include networking and wireless communications subsystems for communicating with other computers and peripheral components. Computer 503 can also include means for communicating with removable storage media, such as a compact disc (CD), digital video disc (DVD), and solid state memory such as a flash memory USB drive. System 501 also includes a display 505 and a printer 507, which both serve as examples of output devices for computer 503. Printer 507 can be a two-dimensional printer, such as a plotter, laser printer, or ink jet printer. The system 501 further includes a keyboard 509, and a mouse 511, which all serve as examples of input devices for the computer 503. Computer 503 can perform operations for steps within method 401. Computer 503 can perform such operations according to software instructions stored at computer 503, for example on a hard drive or on a CD or DVD, or stored remotely on another computer or server. Where instructions are stored remotely, some or all of the computer processing may be performed by computer 503 and/or by the remote computer or server.

The method of the present application provides significant advantages, including: (1) providing a customer with a WAAS enabled aircraft and WAAS infrastructure in a single sales process; (2) allowing a customer to justify the purchase of a safer and more efficient aircraft by providing WAAS infrastructure at least partially in conjunction delivery of the aircraft; (3) allowing the customer to finance the WAAS infrastructure along with the price of the WAAS enabled aircraft; and (4) preventing the customer from having to wait long periods of time for development of WAAS infrastructure after delivery of a WAAS enabled aircraft.

The particular embodiments disclosed above are illustrative only, as the application may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the application. Accordingly, the protection sought herein is as set forth in the claims below. It is apparent that an application with significant advantages has been described and illustrated. Although the present application is shown in a limited number of forms, it is not limited to just these forms, but is amenable to various changes and modifications without departing from the spirit thereof.

1. A computer-implemented method for providing a WAAS infrastructure in conjunction with a sale of a WAAS enabled aircraft, comprising:
receiving a communication from a customer regarding a purchase of the WAAS enabled aircraft;
developing a sales package for the customer using a computer, the sales package comprising:
a first price for the WAAS enabled aircraft; and
a second price for the WAAS infrastructure;
wherein the sales package allows the customer to purchase the WAAS infrastructure and the WAAS enabled aircraft in a single process;
wherein the WAAS infrastructure represents a flight path between an operator desired departure area and an operator desired landing area.

2. The method according to claim 1, further comprising:
delivering the WAAS enabled aircraft to the customer after at least partially developing the WAAS infrastructure.

3. The method according to claim 2, further comprising:
maintaining the WAAS infrastructure after delivering the WAAS enabled aircraft to the customer after at least partially developing the WAAS infrastructure.

4. A method, comprising:
offering development of a WAAS infrastructure in conjunction with a sale of a WAAS enabled aircraft;
assembling the WAAS enabled aircraft;
developing the WAAS infrastructure using a computer; and
providing the WAAS enabled aircraft and the WAAS infrastructure;
wherein the WAAS infrastructure allows a customer of the WAAS enabled aircraft to operate the WAAS enabled aircraft in a WAAS environment.

5. The method according to claim 4, wherein the WAAS infrastructure comprises:
a WAAS flight procedure representing a flight path between an operator desired departure area and an operator desired landing area.

6. The method according to claim 5, further comprising:
packaging the WAAS flight procedure on a memory device, the memory device being configured to be readable by the WAAS enabled aircraft.

7. The method according to claim 5, wherein the WAAS flight procedure includes a localizer performance with vertical guidance approach procedure to facilitate an approach and landing at the operator desired landing area.

8. The method according to claim 5, wherein the WAAS flight procedure enables an operator to fly between the operator desired departure area and the operator desired landing area during low visibility weather conditions.

9. The method according to claim 5, further comprising:
maintaining the WAAS flight procedure for an operator.

10. The method according to claim 4, wherein the offering development of a WAAS infrastructure in conjunction with a sale of a WAAS enabled aircraft is performed by a single entity, thereby allowing a customer to negotiate a price of a sales package which includes both the WAAS enabled aircraft and the WAAS infrastructure.

11. The method according to claim 4, wherein the assembling the WAAS enabled aircraft and the developing the WAAS infrastructure using a computer occur concurrently.

12. The method according to claim 4, wherein the assembling a WAAS enabled aircraft comprises:
transforming an airframe into the WAAS enabled aircraft by installing a WAAS system in the airframe.

13. The method according to claim 4, further comprising:
training an operator in flying the WAAS enabled aircraft.

14. The method according to claim 4, wherein developing the WAAS infrastructure using a computer comprises:
inspecting a desired departure area and a desired landing area for compatibility with WAAS flight guidelines and abilities of the WAAS enabled aircraft.

15. A method for accelerating the introduction of WAAS enabled aircraft into an aviation community, comprising:
manufacturing a WAAS enabled aircraft;
developing a WAAS infrastructure concurrently with the manufacturing of the WAAS enabled aircraft;
wherein the WAAS infrastructure allows a customer of the WAAS enabled aircraft to operate the WAAS enabled aircraft in a WAAS environment, thereby improving safety of the aviation community.

16. The method according to claim 15, wherein the WAAS infrastructure allows a customer of the WAAS enabled aircraft to operate the WAAS enabled aircraft in a WAAS environment, thereby increasing the efficiency of the WAAS enabled aircraft.

17. The method according to claim 15, wherein the developing a WAAS infrastructure at least partially concurrent with the manufacturing the WAAS enabled aircraft allows the customer to operate the WAAS enabled aircraft in a WAAS environment upon taking delivery of the WAAS enabled aircraft.

18. The method according to claim 15, wherein the manufacturing the WAAS enabled aircraft and the developing the WAAS infrastructure, are performed by a persons under the direction of a single entity.

19. The method according to claim 15, wherein the WAAS infrastructure includes a WAAS flight procedure.

20. A method according to claim 15, further comprising:
loading the WAAS infrastructure into an avionics system of the WAAS enabled aircraft.
